(19) United States
(12) Patent Application Publication
(10) Pub. No.: US 2024/0349098 A1
(43) Pub. Date: Oct. 17, 2024

(54) MULTIPLE CHANNEL STATE INFORMATION (CSI) REPORTS CONFIGURATION

(71) Applicant: QUALCOMM Incorporated, San Diego, CA (US)

(72) Inventors: Runxin WANG, San Diego, CA (US); Yu ZHANG, San Diego, CA (US); Muhammad Sayed Khairy ABDELGHAFFAR, San Jose, CA (US)

(21) Appl. No.: 18/294,946

(22) PCT Filed: Oct. 13, 2021
(86) PCT No.: PCT/CN2021/123448

§ 371 Date: Feb. 2, 2024

(51) Int. Cl. H04W 24/10

(52) U.S. Cl. CPC H04W 24/10

(57) ABSTRACT

Certain aspects of the present disclosure provide a method for wireless communication by a user equipment (UE). The UE receives, from a network entity, at least one channel state information (CSI) report configuration configuring the UE to transmit, to the network entity, a base CSI report and one or more differential CSI reports that include at least some CSI values reported relative to CSI values in the base CSI report. The UE transmits the base CSI report and the one or more differential CSI reports to the network entity, in accordance with the at least one CSI report configuration.

### BACKGROUND

### Field of the Disclosure

Aspects of the present disclosure relate to wireless communications, and more particularly, to techniques for managing and configuring multiple channel state information (CSI) reports.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd generation partnership project (3GPP) long term evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New Radio (NR) (e.g., 5^{th} generation (5G)) is an example of an emerging telecommunication standard. NR is a set of enhancements to the LTE mobile standard promulgated by 3GPP. It is designed to better support mobile broadband Internet access by improving spectral efficiency, lowering costs, improving services, making use of new spectrum, and better integrating with other open standards using OFDMA with a cyclic prefix (CP) on a downlink (DL) and on an uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include improved and desirable techniques for managing and configuring multiple channel state information (CSI) reports.

Certain aspects of the subject matter described in this disclosure can be implemented in a method for wireless communications by a user equipment (UE). The method generally includes receiving, from a network entity, at least one CSI report configuration configuring the UE to transmit, to the network entity, a base CSI report and one or more differential CSI reports that include at least some CSI values reported relative to CSI values in the base CSI report; and transmitting the base CSI report and the one or more differential CSI reports to the network entity, in accordance with the at least one CSI report configuration.

Certain aspects of the subject matter described in this disclosure can be implemented in an apparatus for wireless communications by a UE. The apparatus generally includes at least one application processor and a memory configured to: receive, from a network entity, at least one CSI report configuration configuring the UE to transmit, to the network entity, a base CSI report and one or more differential CSI reports that include at least some CSI values reported relative to CSI values in the base CSI report; and transmit the base CSI report and the one or more differential CSI reports to the network entity, in accordance with the at least one CSI report configuration.

Certain aspects of the subject matter described in this disclosure can be implemented in an apparatus for wireless communications by a UE. The apparatus generally includes means for receiving, from a network entity, at least one CSI report configuration configuring the UE to transmit, to the network entity, a base CSI report and one or more differential CSI reports that include at least some CSI values reported relative to CSI values in the base CSI report; and means for transmitting the base CSI report and the one or more differential CSI reports to the network entity, in accordance with the at least one CSI report configuration.

Certain aspects of the subject matter described in this disclosure can be implemented in a computer readable medium storing computer executable code thereon for wireless communications by a UE. The computer readable medium generally includes code for receiving, from a network entity, at least one CSI report configuration configuring the UE to transmit, to the network entity, a base CSI report and one or more differential CSI reports that include at least some CSI values reported relative to CSI values in the base CSI report; and code for transmitting the base CSI report and the one or more differential CSI reports to the network entity, in accordance with the at least one CSI report configuration.

Certain aspects of the subject matter described in this disclosure can be implemented in a method for wireless communications by a network entity. The method generally includes transmitting, to a UE, at least one CSI report configuration configuring the UE to transmit, to the network entity, a base CSI report and one or more differential CSI reports that include at least some CSI values reported relative to CSI values in the base CSI report; and receiving, from the UE, the base CSI report and the one or more differential CSI reports, in accordance with the at least one CSI report configuration.

Certain aspects of the subject matter described in this disclosure can be implemented in an apparatus for wireless communications by a network entity. The apparatus generally includes at least one application processor and a memory configured to: transmit, to a UE, at least one CSI report configuration configuring the UE to transmit, to the network entity, a base CSI report and one or more differential CSI reports that include at least some CSI values reported relative to CSI values in the base CSI report; and receive, from the UE, the base CSI report and the one or more differential CSI reports, in accordance with the at least one CSI report configuration.

Certain aspects of the subject matter described in this disclosure can be implemented in an apparatus for wireless communications by a network entity. The apparatus generally includes means for transmitting, to a UE, at least one CSI report configuration configuring the UE to transmit, to the network entity, a base CSI report and one or more differential CSI reports that include at least some CSI values reported relative to CSI values in the base CSI report; and means for receiving, from the UE, the base CSI report and the one or more differential CSI reports, in accordance with the at least one CSI report configuration.

Certain aspects of the subject matter described in this disclosure can be implemented in a computer readable medium storing computer executable code thereon for wireless communications by a network entity. The computer readable medium generally includes code for transmitting, to a UE, at least one CSI report configuration configuring the UE to transmit, to the network entity, a base CSI report and one or more differential CSI reports that include at least some CSI values reported relative to CSI values in the base CSI report; and code for receiving, from the UE, the base CSI report and the one or more differential CSI reports, in accordance with the at least one CSI report configuration.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and a user equipment (UE), in accordance with certain aspects of the present disclosure.

FIG. 3 is an example frame format for certain wireless communication systems (e.g., a new radio (NR)), in accordance with certain aspects of the present disclosure.

FIG. 4 illustrates transmission of a base channel state information (CSI) report and multiple differential CSI reports, in accordance with certain aspects of the present disclosure.

FIG. 5 is a flow diagram illustrating example operations for wireless communications by a UE, in accordance with certain aspects of the present disclosure.

FIG. 6 is a flow diagram illustrating example operations for wireless communications by a network entity, in accordance with certain aspects of the present disclosure.

FIG. 7 illustrates example CSI report configuration, in accordance with certain aspects of the present disclosure.

FIG. 8A illustrates transmission of base CSI reports based on one periodicity and differential CSI reports based on another periodicity, in accordance with certain aspects of the present disclosure.

FIG. 8B illustrates transmission of base CSI reports based on a certain periodicity, in accordance with certain aspects of the present disclosure.

FIG. 8C illustrates transmission of differential CSI reports based on a certain periodicity, in accordance with certain aspects of the present disclosure.

FIG. 8D illustrates transmission of base CSI reports and differential CSI reports based on a same periodicity, in accordance with certain aspects of the present disclosure.

FIG. 9 illustrates example gap between different CSI reports, in accordance with certain aspects of the present disclosure.

FIG. 10 illustrates example transmission of a base CSI report and multiple differential CSI reports based on different CSI report configurations, in accordance with certain aspects of the present disclosure.

FIG. 11 illustrates example CSI report configuration indicating a periodicity and an offset of a CSI report, in accordance with certain aspects of the present disclosure.

FIG. 12 illustrates example CSI report configuration indicating a periodicity and an offset of different CSI reports, in accordance with certain aspects of the present disclosure.

FIG. 13 illustrates example CSI report configuration indicating a reference CSI report, in accordance with certain aspects of the present disclosure.

FIG. 14 illustrates a communications device that may include various components configured to perform operations for the techniques disclosed herein, in accordance with certain aspects of the present disclosure.

FIG. 15 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatuses, methods, processing systems, and computer readable mediums for managing and configuring channel state information (CSI) reports.

In some cases, a user equipment (UE) sends channel feedback via CSI reports to a network entity at different time intervals. To reduce a time domain overhead for CSI feedback, multiple differential CSI reports may be configured. A differential CSI report may be based on a base CSI report/previous CSI report using differential or other functions. The differential CSI report may include some CSI values relative to CSI values in the base CSI report/previous CSI report. Accordingly, the UE generates and sends a base CSI report and differential CSI reports, based on a configuration of the base CSI report and the differential CSI reports, to reduce a time domain overhead for CSI feedback. For example, the UE may receive a CSI report configuration from the network entity. The CSI report configuration may indicate a periodicity of base CSI reports and differential CSI reports. The CSI report configuration may further indicate a gap between transmissions of two CSI reports. The UE then generates and transmits the base CSI reports and the differential CSI reports to the network entity, in accordance with the CSI report configuration.

The following description provides examples of managing and configuring CSI reports in wireless communication systems. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3^{rd} generation (3G), 4G, and/or new radio (e.g., 5G new radio (NR)) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

### Example Wireless Communications System

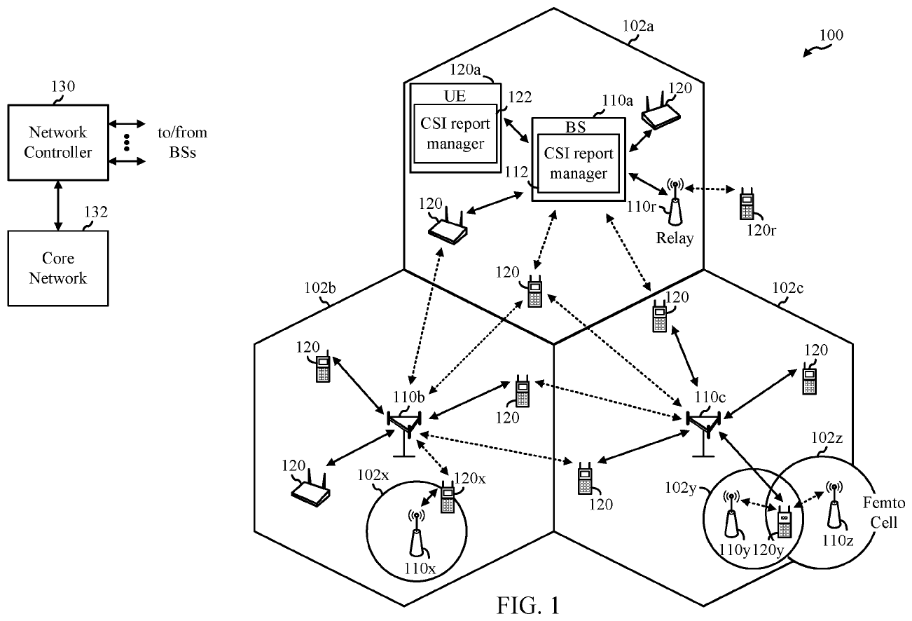

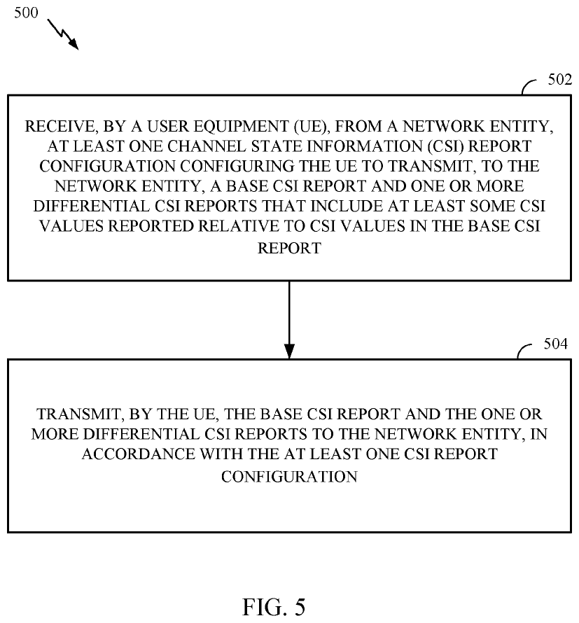

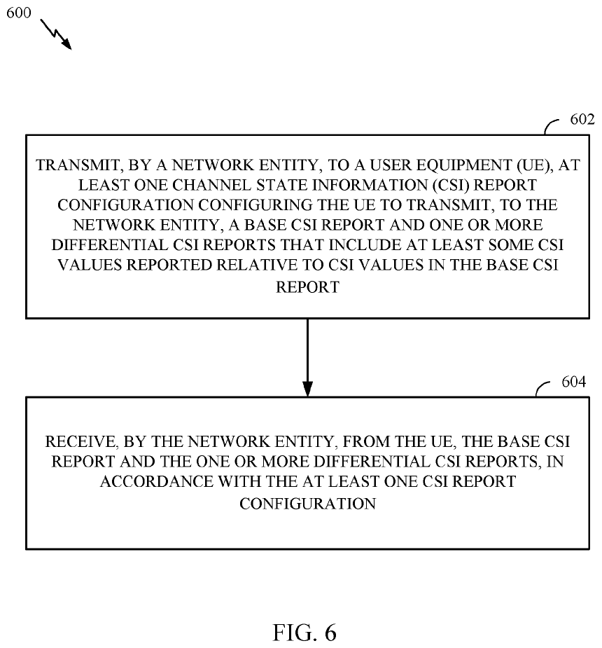

FIG. 1 illustrates an example wireless communication network 100 in which aspects of the present disclosure may be performed. For example, according to certain aspects, the wireless communication network 100 may include base stations (BSs) 110 and/or user equipments (UEs) 120 configured for managing channel state information (CSI) reports. As shown in FIG. 1, a UE 120a includes a CSI report manager 122 configured to perform operations 500 of FIG. 5, and a BS 110a includes a CSI report manager 112 configured to perform operations 600 of FIG. 6.

The wireless communication network 100 may be a new radio (NR) system (e.g., a 5^{th} generation (5G) NR network). As shown in FIG. 1, the wireless communication network 100 may be in communication with a core network. The core network may in communication with BSs 110a-z (each also individually referred to herein as a BS 110 or collectively as BSs 110) and/or UEs 120a-y (each also individually referred to herein as a UE 120 or collectively as UEs 120) in the wireless communication network 100 via one or more interfaces.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS 110 may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

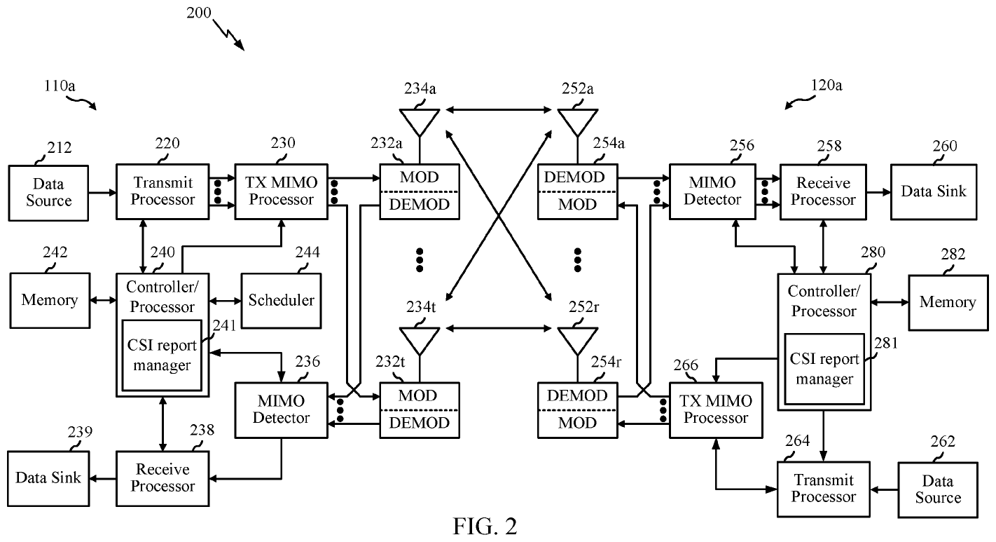

FIG. 2 illustrates example components of a BS 110a and a UE 120a (e.g., in the wireless communication network 100 of FIG. 1).

At the BS 110a, a transmit processor 220 may receive data from a data source 212 and control information from a controller/processor 240. The control information may be for a physical broadcast channel (PBCH), a physical control format indicator channel (PCFICH), a physical hybrid ARQ (automatic repeat request) indicator channel (PHICH), a physical downlink control channel (PDCCH), a group common PDCCH (GC PDCCH), etc. The data may be for a physical downlink shared channel (PDSCH), etc. A medium access control-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The transmit processor 220 may process (e.g., encode and symbol map) the data and control information to obtain data symbols and control symbols, respectively. The transmit processor 220 may also generate reference symbols, such as for a primary synchronization signal (PSS), a secondary synchronization signal (SSS), and a channel state information reference signal (CSI-RS). A transmit multiple-input multiple-output (MIMO) processor 230 may perform spatial processing (e.g., precoding) on the data symbols, the control symbols, and/or the reference symbols, if applicable, and may provide output symbol streams to modulators (MODs) in transceivers 232a-232t. Each MOD in transceivers 232a-232t may process a respective output symbol stream (e.g., for orthogonal frequency division multiplexing (OFDM), etc.) to obtain an output sample stream. Each MOD in transceivers 232a-232t may further process (e.g., convert to analog, amplify, filter, and upconvert) the output sample stream to obtain a downlink (DL) signal. The DL signals from the MODs in transceivers 232a-232t may be transmitted via antennas 234a-234t, respectively.

At the UE 120a, antennas 252a-252r may receive DL signals from the BS 110a and may provide received signals to demodulators (DEMODs) in transceivers 254a-254r, respectively. Each DEMOD in the transceiver 254 may condition (e.g., filter, amplify, downconvert, and digitize) a respective received signal to obtain input samples. Each DEMOD in the transceiver 254 may further process the input samples (e.g., for OFDM, etc.) to obtain received symbols. A MIMO detector 256 may obtain received symbols from all the DEMODs in the transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On an uplink (UL), at the UE 120a, a transmit processor 264 may receive and process data (e.g., for a PUSCH) from a data source 262 and control information (e.g., for a physical uplink control channel (PUCCH) from the controller/processor 280. The transmit processor 264 may also generate reference symbols for a reference signal (e.g., for a sounding reference signal (SRS)). The symbols from the transmit processor 264 may be precoded by a transmit MIMO processor 266 if applicable, further processed by the MODs in transceivers 254a-254r (e.g., for SC-FDM, etc.), and transmitted to the BS 110a. At the BS 110a, the UL signals from the UE 120a may be received by the antennas 234, processed by the DEMODs in transceivers 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

Memories 242 and 282 may store data and program codes for the BS 110a and the UE 120a, respectively. A scheduler 244 may schedule the UE 120a for data transmission on a DL and/or an UL.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a CSI report manager 241 that may be configured to perform the operations illustrated in FIG. 6, as well as other operations disclosed herein. As shown in FIG. 2, the controller/processor 280 of the UE 120a has a CSI report manager 281 that may be configured to perform the operations illustrated in FIG. 5, as well as other operations disclosed herein. Although shown at the controller/processor, other components of the UE 120a and the BS 110a may be used to perform the operations described herein.

NR may utilize OFDM with a cyclic prefix (CP) on the UL and the DL. The NR may support half-duplex operation using time division duplexing (TDD). The OFDM and single-carrier frequency division multiplexing (SC-FDM) partition system bandwidth into multiple orthogonal subcarriers, which are also commonly referred to as tones, bins, etc. Each subcarrier may be modulated with data. Modulation symbols may be sent in a frequency domain with the OFDM and in a time domain with the SC-FDM. The spacing between adjacent subcarriers may be fixed, and a total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. The NR may support a base subcarrier spacing (SCS) of 15 KHz and other SCS may be defined with respect to the base SCS (e.g., 30 kHz, 60 kHz, 120 kHz, 240 kHz, etc.).

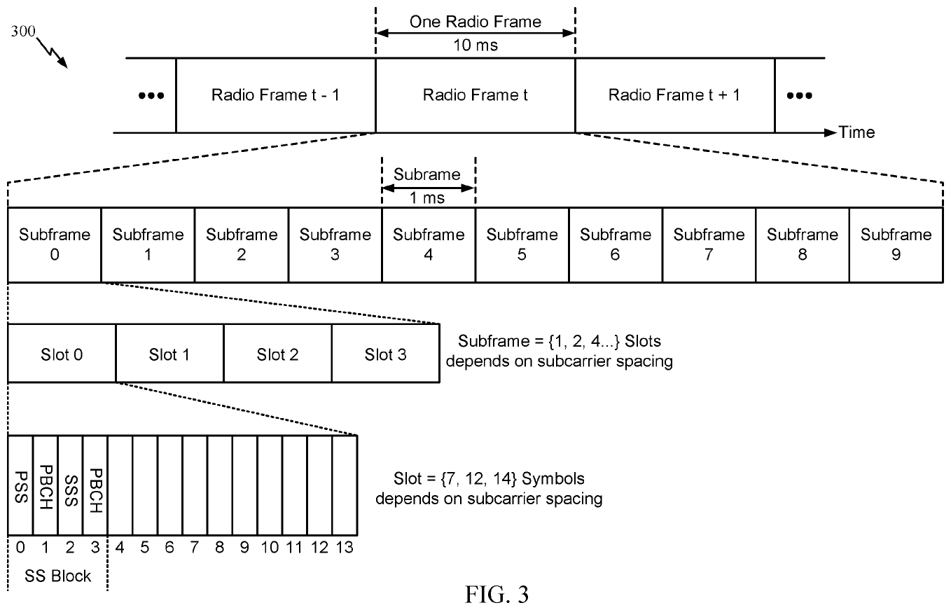

FIG. 3 is a diagram showing an example of a frame format 300 for NR. A transmission timeline for each of DL and UL may be partitioned into units of radio frames. Each radio frame may have a predetermined duration (e.g., 10 ms), and may be partitioned into 10 subframes, each of 1 ms, with indices of 0 through 9. Each subframe may include a variable number of slots (e.g., 1, 2, 4, 8, 16, . . . slots) depending on a SCS. Each slot may include a variable number of symbol periods (e.g., 7, 12, or 14 symbols) depending on the SCS. Symbol periods in each slot may be assigned indices. A sub-slot structure may refer to a transmit time interval having a duration less than a slot (e.g., 2, 3, or 4 symbols). Each symbol in a slot may be configured for a link direction (e.g., a DL, an UL, or a flexible) for data transmission, and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and the SSS may be used by UEs for cell search and acquisition. The PSS may provide half-frame timing, a synchronization signal (SS) may provide a CP length and frame timing. The PSS and the SSS may provide cell identity. The PBCH carries some basic system information, such as DL system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a PDSCH in certain subframes. The SSB can be transmitted up to sixty-four times, for example, with up to sixty-four different beam directions for mmWave. The multiple transmissions of the SSB are referred to as a SS burst set. The SSBs in an SS burst set may be transmitted in the same frequency region, while the SSBs in different SS bursts sets can be transmitted at different frequency regions.

### Example CSI Reports

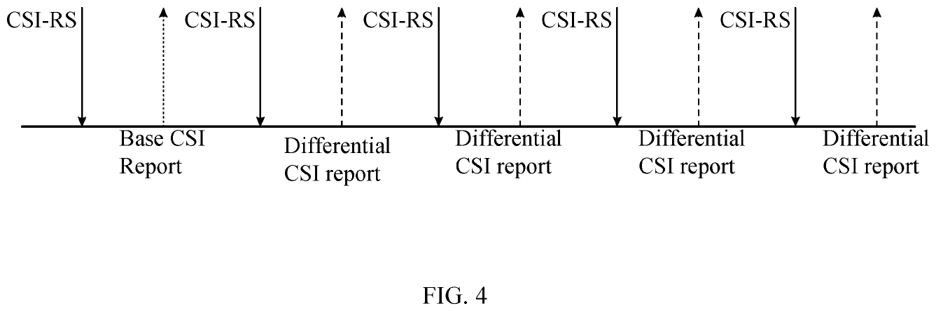

A user equipment (UE) sends channel feedback via channel state information (CSI) reports to a network entity. As illustrated in FIG. 4, a UE sends a base CSI report (including CSI values) to the network entity, in response to receiving signaling (e.g., a CSI-reference signal (CSI-RS)) triggering the UE to transmit a CSI report. After sending the base CSI report, the UE sends differential CSI reports (also known as delta CSI reports) to the network entity (e.g., in response to receiving additional CSI-RSs triggering the UE to transmit additional CSI reports). The UE may calculate a differential CSI report based on the base CSI report/previous CSI report using differential or other functions. The differential CSI report may include some CSI values relative to the CSI values in the base CSI report/previous CSI report.

### Example Multiple CSI Reports Configuration

Aspects of the present disclosure provide apparatuses, methods, processing systems, and computer readable mediums for managing and configuring channel state information (CSI) reports (e.g., base CSI reports and differential CSI reports). For example, a user equipment (UE) receives a CSI report configuration from a network entity. The CSI report configuration configures the CSI reports. The CSI report configuration may indicate a periodicity/offset of the CSI reports and a gap between the CSI reports. The UE generates and transmits the CSI reports to the network entity, in accordance with the CSI report configuration.

FIG. 5 is a flow diagram illustrating example operations 500 for wireless communication by a UE, in accordance with certain aspects of the present disclosure. The operations 500 may be performed, for example, by the UE 120a in the wireless communication network 100. The operations 500 may be implemented as software components that are executed and run on one or more processors (e.g., the controller/processor 280 of FIG. 2). Further, the transmission and reception of signals by the UE in operations 500 may be enabled, for example, by one or more antennas (e.g., the antennas 252 of FIG. 2). In certain aspects, the transmission and/or reception of signals by the UE may be implemented via a bus interface of one or more processors (e.g., the controller/processor 280) obtaining and/or outputting signals.

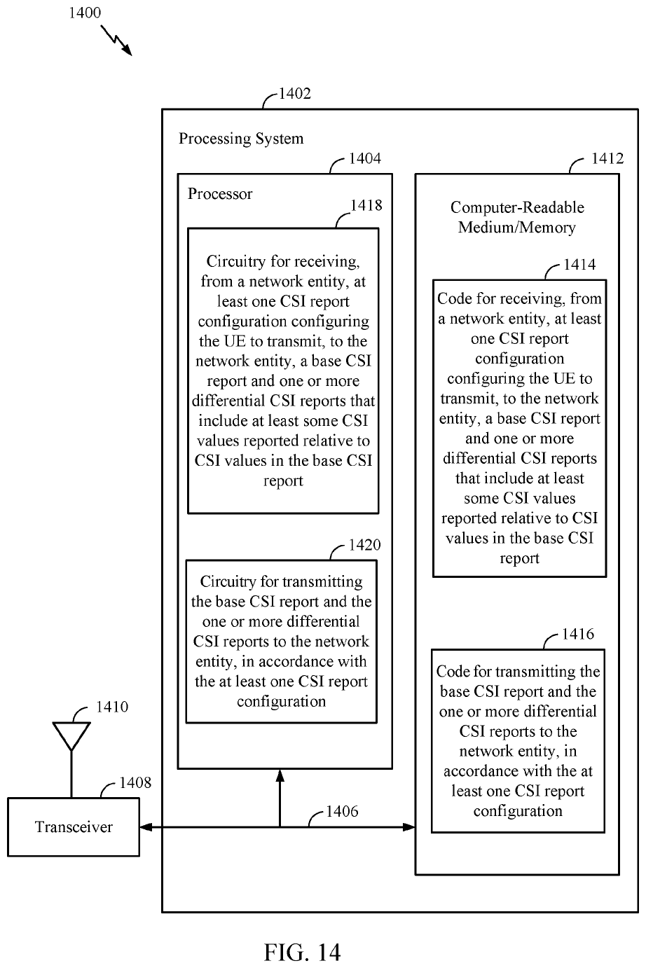

The operations 500 begin, at 502, by receiving, from a network entity, at least one CSI report configuration configuring the UE to transmit, to the network entity, a base CSI report and one or more differential CSI reports that include at least some CSI values reported relative to CSI values in the base CSI report. For example, the UE may receive the at least one CSI report configuration from the network entity using antenna(s) and receiver/transceiver components of the UE 120a shown in FIG. 1 or FIG. 2 and/or of the apparatus shown in FIG. 14.

At 504, the UE transmits the base CSI report and the one or more differential CSI reports to the network entity, in accordance with the at least one CSI report configuration. For example, the UE may transmit the base CSI report and the one or more differential CSI reports to the network entity using antenna(s) and transmitter/transceiver components of the UE 120a shown in FIG. 1 or FIG. 2 and/or of the apparatus shown in FIG. 14.

FIG. 6 is a flow diagram illustrating example operations 600 for wireless communication by a network entity, in accordance with certain aspects of the present disclosure. The operations 600 may be performed, for example, by a network entity (e.g., such as the BS 110a in the wireless communication network 100). The operations 600 may be implemented as software components that are executed and run on one or more processors (e.g., the controller/processor 240 of FIG. 2). Further, the transmission and reception of signals by the network entity in operations 600 may be enabled, for example, by one or more antennas (e.g., the antennas 234 of FIG. 2). In certain aspects, the transmission and/or reception of signals by the network entity may be implemented via a bus interface of one or more processors (e.g., the controller/processor 240) obtaining and/or outputting signals.

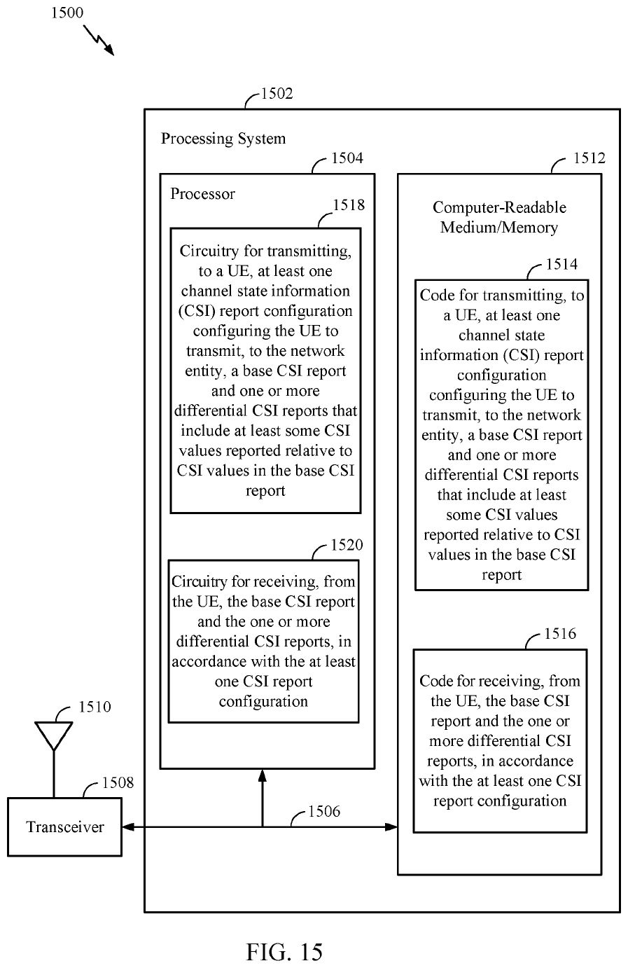

The operations 600 begin, at 602, by transmitting, to a UE, at least one CSI report configuration configuring the UE to transmit, to the network entity, a base CSI report and one or more differential CSI reports that include at least some CSI values reported relative to CSI values in the base CSI report. For example, the network entity may transmit the at least one CSI report configuration to the UE using antenna(s) and transmitter/transceiver components of the BS 110a shown in FIG. 1 or FIG. 2 and/or of the apparatus shown in FIG. 15.

At 604, the network entity receives, from the UE, the base CSI report and the one or more differential CSI reports, in accordance with the at least one CSI report configuration. For example, the network entity may receive the base CSI report and the one or more differential CSI reports from the UE using antenna(s) and receiver/transceiver components of the BS 110a shown in FIG. 1 or FIG. 2 and/or of the apparatus shown in FIG. 15.

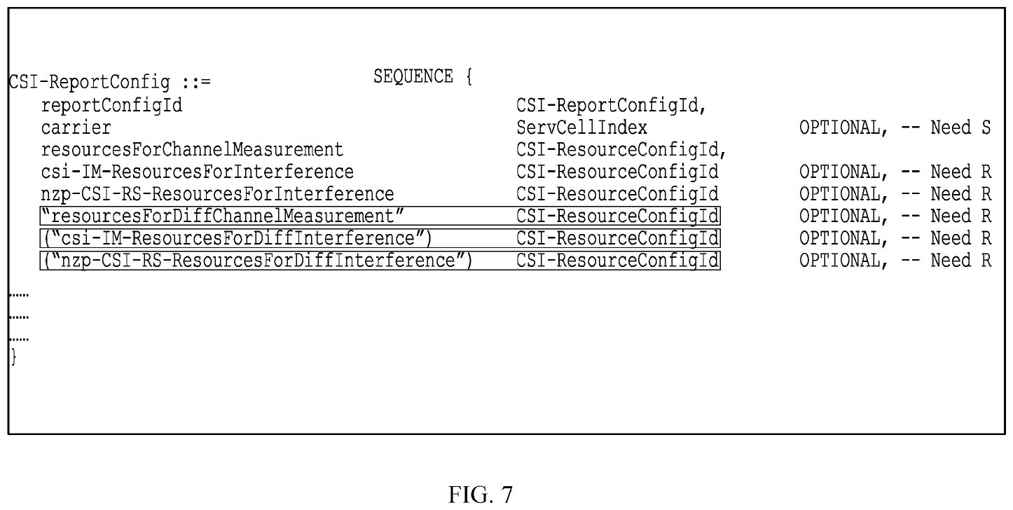

The operations shown in FIGS. 5-6 may be understood with reference to FIGS. 7-13.

In certain aspects, a base CSI report and one or more differential CSI reports are configured in a radio resource control (RRC) configuration message. In certain aspects, the base CSI report and the one or more differential CSI reports are configured in a same CSI report configuration. In one example, a UE may receive a CSI report configuration from a network entity via a downlink control information (DCI). In another example, a UE may receive a CSI report configuration from a network entity via a medium access control (MAC) control element (CE). One example of a CSI report configuration is shown in FIG. 7. The UE transmits a base CSI report and one or more differential CSI reports to the network entity, in accordance with the CSI report configuration.

In certain aspects, CSI report configuration indicates no additional mapping (e.g., same resource setting may be used for a base CSI report and a differential CSI report). In certain aspects, CSI report configuration indicates additional resource mapping (e.g., different resource settings may be used for a base CSI report and a differential CSI report). In certain aspects, CSI report configuration indicates different frequency resources may be used for a base CSI report and a differential CSI report (e.g., sparse frequency resources available for a differential CSI report). In certain aspects, CSI report configuration indicates different spatial resources may be used for a base CSI report and a differential CSI report.

In certain aspects, a periodicity of a base CSI report and one or more differential CSI reports is based on a slot number. In certain aspects, a periodicity of a base CSI report and one or more differential CSI reports is based on a system frame number. The periodicity of the base CSI report and the one or more differential CSI reports is configured in a CSI report configuration.

In certain aspects, an offset (e.g., a frame offset) of a base CSI report and one or more differential CSI reports is based on a slot number. In certain aspects, an offset of a base CSI report and one or more differential CSI reports is based on a system frame number. The offset of the base CSI report and the one or more differential CSI reports is configured in a CSI report configuration.

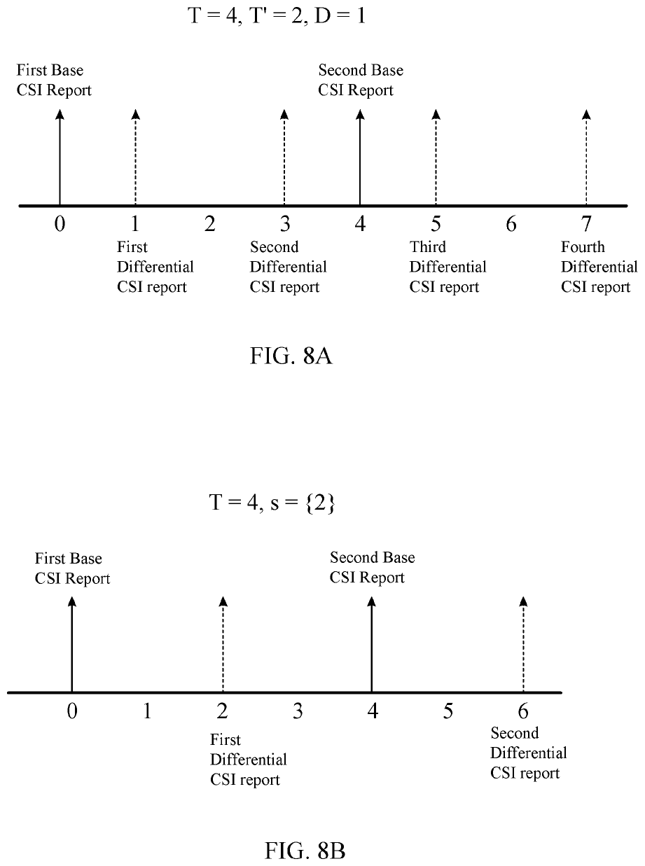

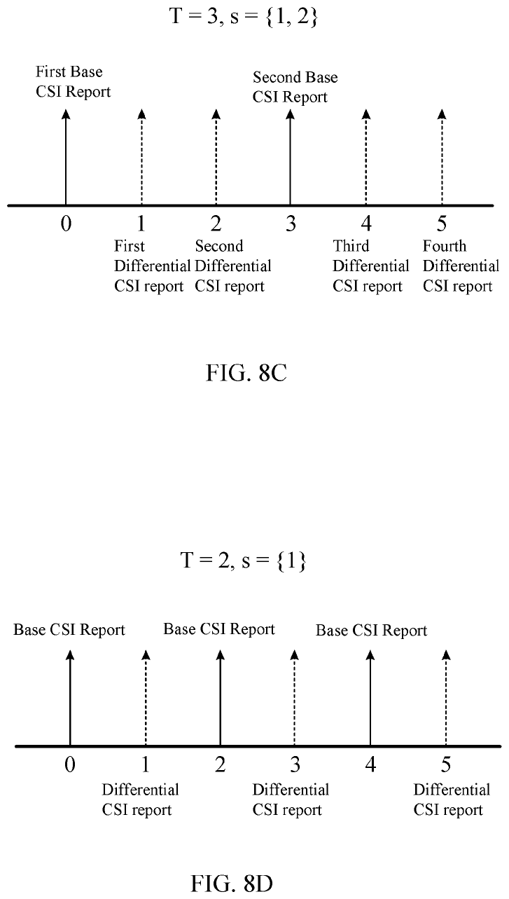

In certain aspects, a UE receives signaling triggering the UE to transmit a differential CSI report to a network entity. In response to the signaling, the UE calculates the differential CSI report. The UE may calculate the differential CSI report based on a nearest base CSI report before the differential CSI report. For example, as illustrated in FIG. 8A, a UE calculates a first differential CSI report and a second CSI differential report based on a first base CSI report, and a third differential CSI report and a fourth CSI differential report based on a second base CSI report.

In certain aspects, a UE skips a base CSI report when there is no base CSI report before one or more differential CSI reports.

In certain aspects, a UE transmits a base CSI report to a network entity, when a modulus function of a slot number and a periodicity satisfies a condition. For example, if mod (slot number, T)==0, a base CSI report is transmitted. In this example, T represents a periodicity for base CSI reports. The slot number and the periodicity are configured in a CSI report configuration. As illustrated in FIG. 8A, when a modulus function of a slot number and a periodicity (e.g., T=4) is 0, a first base CSI report is transmitted at a slot number 0 and a second base CSI report is transmitted at a slot number 4 (based on the periodicity value of 4).

In certain aspects, a UE transmits one or more differential CSI reports to a network entity, when a first modulus function of a slot number and a first periodicity satisfies a first condition. For example, if mod (slot number, T)=={s1, s2, . . . }, differential CSI reports are transmitted. In this example, T represents a first periodicity for differential CSI reports. The slot numbers (s1, s2, etc.) and the first periodicity are configured in a CSI report configuration. In one example, as illustrated in FIG. 8B, based on a first modulus function of a slot number (e.g., 2) and a periodicity (e.g., 4), a first differential CSI report is transmitted at a slot number 2 and a second differential CSI report is transmitted at a slot number 6 (based on the periodicity value of 4). In another example, as illustrated in FIG. 8C, based on a first modulus function of a slot number (e.g., 1, 2) and a periodicity (e.g., 3), a first differential CSI report is transmitted at a slot number 1, a second differential CSI report is transmitted at a slot number 2, a third differential CSI report is transmitted at a slot number 4 (based on the periodicity value of 3), and a fourth differential CSI report is transmitted at a slot number 5 (based on the periodicity value of 3).

In certain aspects, a UE transmits one or more differential CSI reports to a network entity, during a duration between two base CSI reports, when a second modulus function of an output (e.g., of a first modulus function) and a second periodicity satisfies a second condition. For example, if mod (mod (slot number, T), T′)==D, differential CSI reports are transmitted. In this example, T represents a first periodicity for base CSI reports, T′ represents a second periodicity for differential CSI reports, and D indicates a slot number. The slot numbers, the first periodicity, and the second periodicity are configured in a CSI report configuration. As illustrated in FIG. 8A, when T=4, T′=2, and D=1, a first differential CSI report is transmitted at a slot number 1 and a second differential CSI report is transmitted at a slot number 3 (based on the second periodicity value of 2), between a first base CSI report transmitted at a slot number 0 and a second base CSI report is transmitted at a slot number 4 (based on the first periodicity value of 4).

In certain aspects, a UE may transmit a base CSI report, a differential CSI report or no report based on certain conditions. For example, when mod (slot number, T) meets specific conditions, the UE transmits some CSI report or no report to a network entity. In this example, T represents a periodicity of a CSI report. As illustrated in FIG. 8D, when T=2 and slot number-1 satisfies some conditions, each base CSI report and different CSI report is transmitted in alternate slots (based on the periodicity value of 2).

In certain aspects, a gap (e.g., time gap) between transmissions of two CSI reports (e.g., base CSI reports and differential CSI reports) may be same. For example, as illustrated in FIG. 8D, a gap between transmissions of any two CSI reports to a network entity is same.

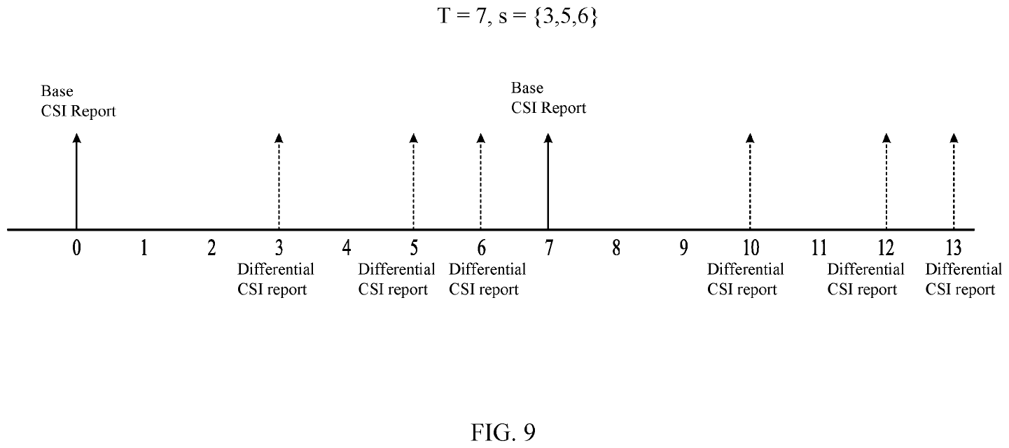

In certain aspects, a gap between transmissions of two CSI reports may be different. In one example, a gap between two CSI reports may be small or large. In another example, a gap between two CSI reports may be based on a periodic pattern. For example, as illustrated in FIG. 9, a gap between transmissions of two CSI reports to a network entity is different.

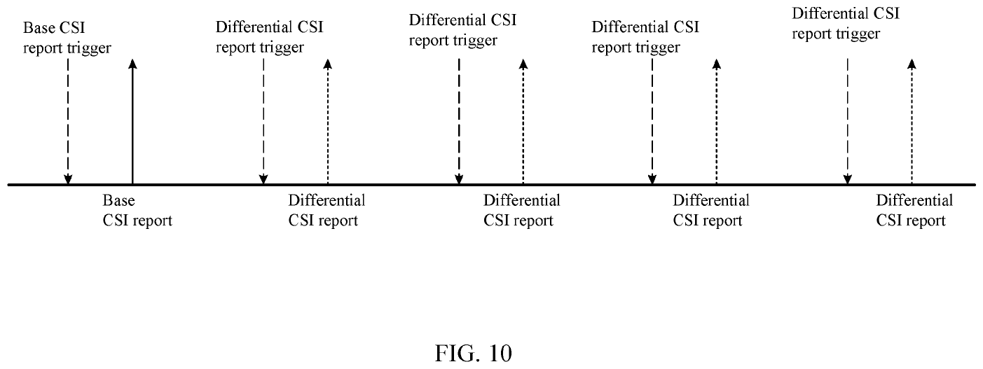

In certain aspects, a base CSI report and one or more differential CSI reports are configured in different CSI report configurations. In certain aspects, a base CSI report and one or more differential CSI reports are triggered separately (e.g., based on different CSI report configurations). For example, as illustrated in FIG. 10, a base CSI report is triggered based on a base CSI report trigger signal, and each differential CSI report is triggered based on a corresponding differential CSI report signal.

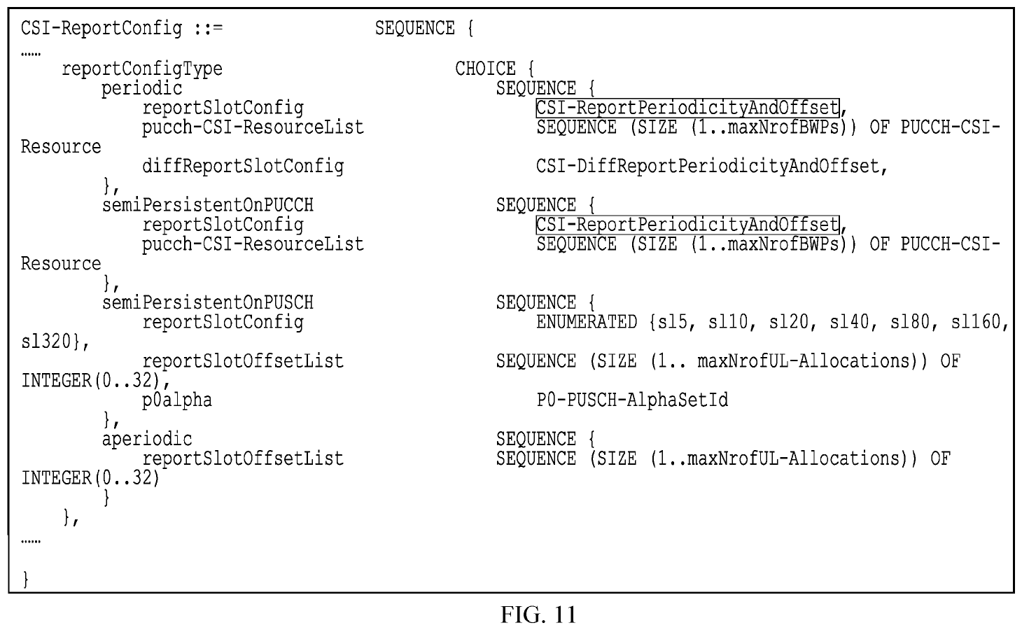

In certain aspects, a periodicity of each base CSI report and each differential CSI report is configured in their corresponding CSI report configuration. In certain aspects, an offset of each base CSI report and each differential CSI report is configured in their corresponding CSI report configuration. An example CSI report configuration indicating a periodicity and an offset of a CSI report is shown in FIG. 11.

In certain aspects, a gap between two CSI reports may be based on a trigger time of the CSI reports.

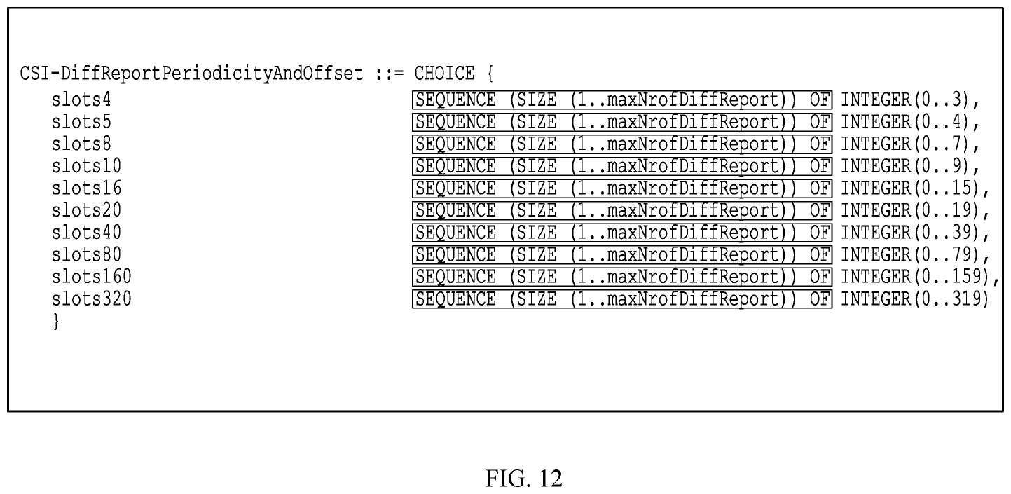

In certain aspects, one or more differential CSI reports are configured in an RRC configuration message. In certain aspects, one or more differential CSI reports are configured in a same CSI report configuration. In certain aspects, a periodicity of one or more differential CSI reports are configured in a same CSI report configuration. In certain aspects, one or more offset values of one or more differential CSI reports are configured in a same CSI report configuration. An example CSI report configuration indicating a periodicity and an offset of different CSI reports is shown in FIG. 12.

In certain aspects, each differential CSI report may be configured in a different CSI report configuration. In certain aspects, each differential CSI report may be triggered separately (e.g., based on their corresponding CSI report configuration).

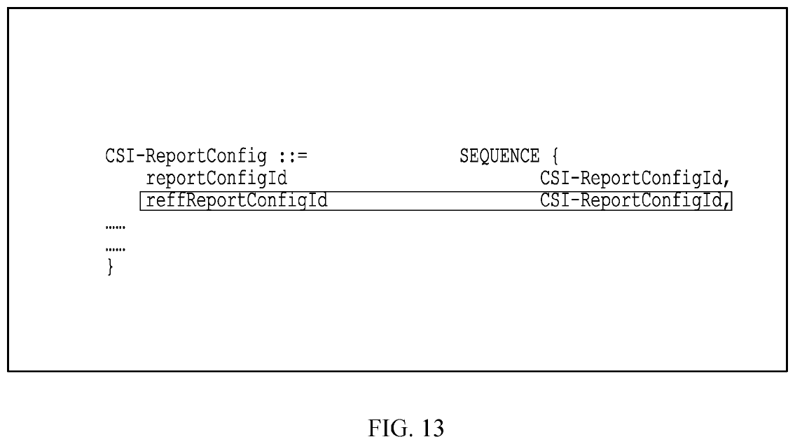

In certain aspects, a CSI report configuration may indicate a reference report identification (ID). In one example, a reference report ID may be a base CSI report. In another example, a reference report ID may be a differential CSI report. An example CSI report configuration indicating a reference CSI report is shown in FIG. 13.

### Example Wireless Communication Devices

FIG. 14 illustrates a communications device 1400 that may include various components (e.g., corresponding to means-plus-function components) configured to perform operations for the techniques disclosed herein, such as the operations illustrated in FIG. 5. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 is configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., a computer-executable code) that when executed by the processor 1404, cause the processor 1404 to perform the operations illustrated in FIG. 5, or other operations for performing the various techniques discussed herein. In certain aspects, computer-readable medium/memory 1412 stores code 1414 for receiving and code 1416 for transmitting. The code 1414 for receiving may include code for receiving, from a network entity, at least one channel state information (CSI) report configuration configuring the UE to transmit, to the network entity, a base CSI report and one or more differential CSI reports that include at least some CSI values reported relative to CSI values in the base CSI report. The code 1416 for transmitting may include code for transmitting the base CSI report and the one or more differential CSI reports to the network entity, in accordance with the at least one CSI report configuration.

The processor 1404 may include circuitry configured to implement the code stored in the computer-readable medium/memory 1412, such as for performing the operations illustrated in FIG. 5, as well as other operations for performing the various techniques discussed herein. For example, the processor 1404 includes circuitry 1418 for receiving and circuitry 1420 for transmitting. The circuitry 1418 for receiving may include circuitry for receiving, from a network entity, at least one CSI report configuration configuring the UE to transmit, to the network entity, a base CSI report and one or more differential CSI reports that include at least some CSI values reported relative to CSI values in the base CSI report. The circuitry 1420 for transmitting may include circuitry for transmitting the base CSI report and the one or more differential CSI reports to the network entity, in accordance with the at least one CSI report configuration.

FIG. 15 illustrates a communications device 1500 that may include various components (e.g., corresponding to means-plus-function components) configured to perform operations for the techniques disclosed herein, such as the operations illustrated in FIG. 6. The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 is configured to perform processing functions for the communications device 1500, including processing signals received and/or to be transmitted by the communications device 1500.

The processing system 1502 includes a processor 1504 coupled to a computer-readable medium/memory 1512 via a bus 1506. In certain aspects, the computer-readable medium/memory 1512 is configured to store instructions (e.g., a computer-executable code) that when executed by the processor 1504, cause the processor 1504 to perform the operations illustrated in FIG. 6, or other operations for performing the various techniques discussed herein. In certain aspects, computer-readable medium/memory 1512 stores code 1514 for transmitting and code 1516 for receiving. The code 1514 for transmitting may include code for transmitting, to a user equipment (UE), at least one CSI report configuration configuring the UE to transmit, to the network entity, a base CSI report and one or more differential CSI reports that include at least some CSI values reported relative to CSI values in the base CSI report. The code 1516 for receiving may include code for receiving, from the UE, the base CSI report and the one or more differential CSI reports, in accordance with the at least one CSI report configuration.

The processor 1504 may include circuitry configured to implement the code stored in the computer-readable medium/memory 1512, such as for performing the operations illustrated in FIG. 6, as well as other operations for performing the various techniques discussed herein. For example, the processor 1504 includes circuitry 1518 for transmitting and circuitry 1520 for receiving. The circuitry 1518 for transmitting may include circuitry for transmitting, to a UE, at least one CSI report configuration configuring the UE to transmit, to the network entity, a base CSI report and one or more differential CSI reports that include at least some CSI values reported relative to CSI values in the base CSI report. The circuitry 1520 for receiving may include circuitry for receiving, from the UE, the base CSI report and the one or more differential CSI reports, in accordance with the at least one CSI report configuration.

### Example Aspects

Implementation examples are described in the following numbered aspects.

In a first aspect, a method for wireless communications by a user equipment (UE), comprising: receiving, from a network entity, at least one channel state information (CSI) report configuration configuring the UE to transmit, to the network entity, a base CSI report and one or more differential CSI reports that include at least some CSI values reported relative to CSI values in the base CSI report; and transmitting the base CSI report and the one or more differential CSI reports to the network entity, in accordance with the at least one CSI report configuration.

In a second aspect, alone or in combination with the first aspect, the base CSI report and the one or more differential CSI reports are configured in a radio resource control (RRC) configuration message.

In a third aspect, alone or in combination with one or more of the first and second aspects, a periodicity and an offset of the base CSI report and the one or more differential CSI reports is based on at least one of: a system frame number or a slot number.

In a fourth aspect, alone or in combination with one or more of the first through third aspects, calculating a differential CSI report based on a nearest base CSI report before the differential CSI report.

In a fifth aspect, alone or in combination with one or more of the first through fourth aspects, skipping the base CSI report when there is no base CSI report before the one or more differential CSI reports.

In a sixth aspect, alone or in combination with one or more of the first through fifth aspects, a gap between two CSI reports comprising the base CSI report and the one or more differential CSI reports is same.

In a seventh aspect, alone or in combination with one or more of the first through fifth aspects, a gap between two CSI reports comprising the base CSI report and the one or more differential CSI reports is different.

In an eighth aspect, alone or in combination with the first aspect, the base CSI report and the one or more differential CSI reports are configured in different CSI report configurations.

In a ninth aspect, alone or in combination with one or more of the first and eighth aspects, the base CSI report and the one or more differential CSI reports are triggered separately.

In a tenth aspect, alone or in combination with one or more of the first and eighth aspects, a gap between two CSI reports comprising the base CSI report and the one or more differential CSI reports is based on a trigger time.

In an eleventh aspect, alone or in combination with one or more of the first and eighth aspects, the one or more differential CSI reports are configured in a radio resource control (RRC) configuration message.

In a twelfth aspect, alone or in combination with one or more of the first and eleventh aspects, a periodicity and one or more offset values of the one or more differential CSI reports are configured in a CSI report configuration.

In a thirteenth aspect, alone or in combination with one or more of the first and eighth aspects, each differential CSI report is configured in a different CSI report configuration.

In a fourteenth aspect, alone or in combination with one or more of the first and thirteenth aspects, each differential CSI report is triggered separately.

In a fifteenth aspect, alone or in combination with one or more of the first and thirteenth aspects, a periodicity and an offset of each base CSI report and each differential CSI report is configured in their CSI report configuration.

In a sixteenth aspect, alone or in combination with one or more of the first to fifteenth aspects, the base CSI report is transmitted to the network entity, when a modulus function of a slot number and a periodicity satisfies a condition.

In a seventeenth aspect, alone or in combination with one or more of the first to sixteenth aspects, the one or more differential CSI reports are transmitted to the network entity, when a first modulus function of a slot number and a first periodicity satisfies a first condition.

In an eighteenth aspect, alone or in combination with one or more of the first to seventeenth aspects, the one or more differential CSI reports are transmitted to the network entity during a duration between two base CSI reports, when a second modulus function of an output the first modulus function and a second periodicity satisfies a second condition.

In a nineteenth aspect, alone or in combination with one or more of the first to eighteenth aspects, the at least one CSI report configuration indicates a reference report identification (ID) corresponding to the base CSI report or a differential CSI report.

In a twentieth aspect, alone or in combination with one or more of the first and second aspects, the base CSI report and the one or more differential CSI reports are configured in a same CSI report configuration.

In a twenty-first aspect, alone or in combination with one or more of the first and eleventh aspects, the one or more differential CSI reports are configured in a same CSI report configuration.

In a twenty-second aspect, a method for wireless communications by a network entity, comprising: transmitting, to a user equipment (UE), at least one channel state information (CSI) report configuration configuring the UE to transmit, to the network entity, a base CSI report and one or more differential CSI reports that include at least some CSI values reported relative to CSI values in the base CSI report; and receiving, from the UE, the base CSI report and the one or more differential CSI reports, in accordance with the at least one CSI report configuration.

In a twenty-third aspect, alone or in combination with the twenty-second aspect, the base CSI report and the one or more differential CSI reports are configured in a radio resource control (RRC) configuration message.

In a twenty-fourth aspect, alone or in combination with one or more of the twenty-second and twenty-third aspects, a periodicity and an offset of the base CSI report and the one or more differential CSI reports is based on at least one of: a system frame number or a slot number.

In a twenty-fifth aspect, alone or in combination with one or more of the twenty-second to twenty-fourth aspects, a gap between two CSI reports comprising the base CSI report and the one or more differential CSI reports is same.

In a twenty-sixth aspect, alone or in combination with one or more of the twenty-second to twenty-fourth aspects, a gap between two CSI reports comprising the base CSI report and the one or more differential CSI reports is different.

An apparatus for wireless communication, comprising at least one processor; and a memory coupled to the at least one processor, the memory comprising code executable by the at least one processor to cause the apparatus to perform the method of any of the first through twenty-sixth aspects.

An apparatus comprising means for performing the method of any of the first through twenty-sixth aspects.

A computer readable medium storing computer executable code thereon for wireless communications that, when executed by at least one processor, cause an apparatus to perform the method of any of the first through twenty-sixth aspects.

### Additional Considerations

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, allocating, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (UE) 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 5 and 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
receiving, from a network entity, at least one channel state information (CSI) report configuration configuring the UE to transmit, to the network entity, a base CSI report and one or more differential CSI reports that include at least some CSI values reported relative to CSI values in the base CSI report; and
transmitting the base CSI report and the one or more differential CSI reports to the network entity, in accordance with the at least one CSI report configuration.

2. The method of claim 1, wherein the base CSI report and the one or more differential CSI reports are configured in a radio resource control (RRC) configuration message.

3. The method of claim 2, wherein a periodicity and an offset of the base CSI report and the one or more differential CSI reports is based on at least one of: a system frame number or a slot number.

4. The method of claim 2, further comprising calculating a differential CSI report based on a nearest base CSI report before the differential CSI report.

5. The method of claim 2, further comprising skipping the base CSI report when there is no base CSI report before the one or more differential CSI reports.

6. The method of claim 2, wherein a gap between two CSI reports comprising the base CSI report and the one or more differential CSI reports is same.

7. The method of claim 2, wherein a gap between two CSI reports comprising the base CSI report and the one or more differential CSI reports is different.

8. The method of claim 1, wherein the base CSI report and the one or more differential CSI reports are configured in different CSI report configurations.

9. The method of claim 8, wherein the base CSI report and the one or more differential CSI reports are triggered separately.

10. The method of claim 8, wherein a gap between two CSI reports comprising the base CSI report and the one or more differential CSI reports is based on a trigger time.

11. The method of claim 8, wherein the one or more differential CSI reports are configured in a radio resource control (RRC) configuration message.

12. The method of claim 11, wherein a periodicity and one or more offset values of the one or more differential CSI reports are configured in a CSI report configuration.

13. The method of claim 8, wherein each differential CSI report is configured in a different CSI report configuration.

14. The method of claim 13, wherein each differential CSI report is triggered separately.

15. The method of claim 13, wherein a periodicity and an offset of each base CSI report and each differential CSI report is configured in their CSI report configuration.

16. The method of claim 2, wherein the base CSI report is transmitted to the network entity, when a modulus function of a slot number and a periodicity satisfies a condition.

17. The method of claim 2, wherein the one or more differential CSI reports are transmitted to the network entity, when a first modulus function of a slot number and a first periodicity satisfies a first condition.

18. The method of claim 17, wherein the one or more differential CSI reports are transmitted to the network entity during a duration between two base CSI reports, when a second modulus function of an output the first modulus function and a second periodicity satisfies a second condition.

19. The method of claim 1, wherein the at least one CSI report configuration indicates a reference report identification (ID) corresponding to the base CSI report or a differential CSI report.

20. The method of claim 2, wherein the base CSI report and the one or more differential CSI reports are configured in a same CSI report configuration.

21. The method of claim 11, wherein the one or more differential CSI reports are configured in a same CSI report configuration.

22. A method for wireless communications by a network entity, comprising:
transmitting, to a user equipment (UE), at least one channel state information (CSI) report configuration configuring the UE to transmit, to the network entity, a base CSI report and one or more differential CSI reports that include at least some CSI values reported relative to CSI values in the base CSI report; and
receiving, from the UE, the base CSI report and the one or more differential CSI reports, in accordance with the at least one CSI report configuration.

23. The method of claim 22, wherein the base CSI report and the one or more differential CSI reports are configured in a radio resource control (RRC) configuration message.

24. The method of claim 23, wherein a periodicity and an offset of the base CSI report and the one or more differential CSI reports is based on at least one of: a system frame number or a slot number.

25. The method of claim 23, wherein a gap between two CSI reports comprising the base CSI report and the one or more differential CSI reports is same.

26. The method of claim 23, wherein a gap between two CSI reports comprising the base CSI report and the one or more differential CSI reports is different.

27. An apparatus for wireless communications by a user equipment (UE), comprising:
at least one processor and a memory configured to:
receive, from a network entity, at least one channel state information (CSI) report configuration configuring the UE to transmit, to the network entity, a base CSI report and one or more differential CSI reports that include at least some CSI values reported relative to CSI values in the base CSI report; and
transmit the base CSI report and the one or more differential CSI reports to the network entity, in accordance with the at least one CSI report configuration.

28. The apparatus of claim 27, wherein the base CSI report and the one or more differential CSI reports are configured in a radio resource control (RRC) configuration message.

29. An apparatus for wireless communications by a network entity, comprising:
at least one processor and a memory configured to:
transmit, to a user equipment (UE), at least one channel state information (CSI) report configuration configuring the UE to transmit, to the network entity, a base CSI report and one or more differential CSI reports that include at least some CSI values reported relative to CSI values in the base CSI report; and
receive, from the UE, the base CSI report and the one or more differential CSI reports, in accordance with the at least one CSI report configuration.

30. The apparatus of claim 29, wherein the base CSI report and the one or more differential CSI reports are configured in a radio resource control (RRC) configuration message.
